(19) United States
(12) Patent Application Publication
(10) Pub. No.: US 2026/0178184 A1
(43) Pub. Date: Jun. 25, 2026

(54) CONTEXTUAL USER INTERFACES

(71) Applicant: Google LLC, Mountain View, CA (US)

(72) Inventors: Kristin A. Gray, Honolulu, HI (US); Nicolas Hunter Pellegrino, San Francisco, CA (US); Sangeetha Parthasarathi, Santa Clara, CA (US); Kevin Gaunt, San Francisco, CA (US); Jean Soo Hyun, San Francisco, CA (US); Jaeun Park, San Francisco, CA (US)

(21) Appl. No.: 19/425,751

(22) Filed: Dec. 18, 2025

Related U.S. Application Data
(60) Provisional application No. 63/737,085, filed on Dec. 20, 2024.

(51) Int. Cl. G06F 3/0488; G06F 3/01; G06F 3/0484

(52) U.S. Cl. CPC G06F 3/0488; G06F 3/0484; G06F 3/017

(57) ABSTRACT

Techniques are described for an example computing device including at least one processor; a display device; a sensor; and a storage device that stores instructions executable by the at least one processor to: determine, based on a plurality of contextual signals, a context associated with the computing device, select, based on the context, a user interface control from a plurality of user interface controls, and in response to a gesture detected by the sensor, output, for display at the display device, a contextual user interface element configured with the user interface control, the contextual user interface element displayed in a portion of the display device associated with the sensor.

This application claims the benefit of US Provisional Patent Application No. 63/737,085, filed 20 Dec. 2024, the entire contents of which is incorporated herein by reference.

### BACKGROUND

Some computing devices may include touch or other presence sensors that detect user input. For example, a computing device may include a presence-sensitive display that both displays objects and detects user input using presence sensors. Such a presence-sensitive display may enable a user to interact with the computing device by, for example, tapping on a displayed element to initiate an action (e.g., initiating execution of an application, changing information displayed by the presence-sensitive display, etc.), moving a finger across the presence-sensitive display to drag an object and/or cause the computing device to scroll content being displayed by the presence-sensitive display, etc. In another example, a computing device may include pressure-sensitive sensors that adjust physical configurations of the computing device, such as an output volume of the computing device.

### SUMMARY

In general, techniques of this disclosure are directed to techniques for outputting one or more contextual user interfaces with one or more contextual user interface controls determined based on a context of a computing device. A computing device may include a sensor (e.g., a pressure-sensitive sensor, a capacitive pressure sensor, a mechanical button comprising a capacitive touch surface, etc.) configured to trigger an output of a contextual user interface element responsive to a detected gesture. For example, the sensor of the computing device may detect a gesture (e.g., a tactile input such as a touch, a press, a fling, a drag, a long press, a force press, etc.). In response to detecting the gesture, the computing device may output, for display at a portion of a display device that does not obstruct user interaction with the display device, a graphical user interface element configured with a user interface control selected based on a context associated with the computing device. The computing device may determine a context associated with the computing device based on contextual signals collected responsive to obtaining explicit user consent. A context associated with the computing device may include a phone state (e.g., an output volume state, a display brightness state, a power source capacity state, a connection state, etc.), an application state (e.g., software signals indicating application-defined states associated with a user operating the computing device interacting with software applications), an environmental state (e.g., heart rate determined from a health sensor, location determined from a communication sensor, atmospheric pressure determined from a barometer, or other state determined from data collected by a physical sensor of the computing device), and/or other states indicated by data associated with the operation of the computing device.

The computing device may select a user interface control based on a context determined for the computing device. For example, the computing device may output a contextual user interface element including images from an image gallery (e.g., copied from display data generated by a software application) configured with a user interface control to scroll through the images of the image gallery based on a context for the computing device indicating the application state of the computing is associated with viewing images of a photography application. In some examples, the computing device may output a stack of contextual user interface elements configured with respective user interface controls selected based on one or more contexts associated with the computing device. The computing device may output one or more contextual user interface elements in a portion of a display device of the computing device that is associated with the gesture-detecting sensor, such that the contextual user interface element is not obtrusive and/or obstructed by the user operating the computing device.

In one example, a method includes determining, by a computing device and based on a plurality of contextual signals, a context associated with the computing device; selecting, by the computing device and based on the context, a user interface control from a plurality of user interface controls; and in response to a gesture detected by a sensor of the computing device, outputting, by the computing device and for display at a display device of the computing device, a contextual user interface element configured with the user interface control, the contextual user interface element displayed in a portion of the display device associated with the sensor.

In another example, a computing device includes at least one processor; a display device; a sensor; and a storage device that stores instructions executable by the at least one processor to: determine, based on a plurality of contextual signals, a context associated with the computing device, select, based on the context, a user interface control from a plurality of user interface controls, and in response to a gesture detected by the sensor, output, for display at the display device, a contextual user interface element configured with the user interface control, the contextual user interface element displayed in a portion of the display device associated with the sensor.

In another example, a non-transitory computer-readable storage media encoded with instructions that, when executed, cause at least one processor of a computing device to: determine, based on a plurality of contextual signals, a context associated with the computing device, select, based on the context, a user interface control from a plurality of user interface controls, and in response to a gesture detected by a sensor, output, for display at a display device, a contextual user interface element configured with the user interface control, the contextual user interface element displayed in a portion of the display device associated with the sensor.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device including example user interface components for outputting example user interface controls, in accordance with one or more aspects of the present disclosure.

FIG. 2 is a block diagram illustrating an example computing device for outputting user interface elements with contextual user interface controls, in accordance with one or more techniques of this disclosure.

FIG. 3 is a conceptual diagram illustrating an example computing device including an example user interface element with an example user interface control, in accordance with one or more techniques of this disclosure.

FIG. 4 is a conceptual diagram illustrating example gestures for switching example user interface controls, in accordance with one or more techniques of this disclosure.

FIG. 5 is a conceptual diagram illustrating an example computing device including an example contextual user interface element, in accordance with one or more techniques of this disclosure.

FIG. 6 is a flowchart illustrating example operations of an example computing device for outputting contextual user interface elements, in accordance with one or more techniques of the present disclosure.

### DETAILED DESCRIPTION

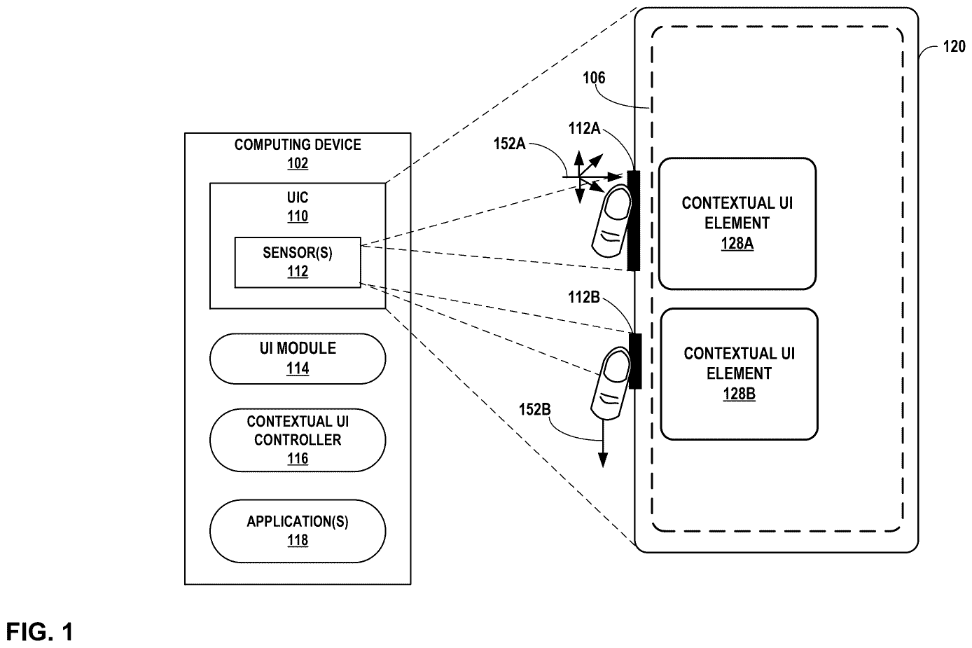

FIG. 1 is a conceptual diagram illustrating example computing device 102 including example user interface components 110 for outputting example user interface controls, in accordance with one or more aspects of the present disclosure. FIG. 1 illustrates only one particular example of computing device 102, and many other examples of computing device 102 may be used in other instances. Computing device 102 may include, but is not limited to, portable, mobile, or other devices, such as mobile phones (including smartphones), wearable computing devices (e.g., smart watches, smart glasses, etc.), laptop computers, desktop computers, tablet computers, smart speakers, smart television platforms, server computers, mainframes, infotainment systems (e.g., vehicle head units), augmented reality and/or virtual reality devices (AR/VR device), spatial computing devices, artificial intelligence (AI) devices, etc. In some examples, computing device 102 may represent a cloud computing system that provides one or more services via a network. That is, in some examples, computing device 102 may be a distributed computing system. Computing device 102 of FIG. 1 may include a subset of the components included in example computing device 102 or may include additional components not shown in FIG. 1. As shown in FIG. 1, computing device 102 includes user interface components (UIC) 110, user interface (UI) module 114, contextual user interface (UI) controller 116, and one or more applications 118 (collectively referred to herein as “applications 118”). UI components 110 may include hardware and/or software for receiving user input and rendering graphical output. Applications 118 may include programs that provide specific functionalities to the user, such as browsing the web, playing media, or managing communications.

UIC 110 may function as an input and/or output device for computing device 102. As shown in FIG. 1, UIC 110 includes presence-sensitive housing 120 and one or more sensors 112. UIC 110 may be implemented using various technologies. For instance, UIC 110 may include input devices such as a presence-sensitive housing and/or one or more presence-sensitive screens, such as capacitive touchscreens or projective capacitance touchscreens. UIC 110 may include presence-sensitive housing 120 such as a capacitive housing. UIC 110 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 102. In the example of FIG. 1, presence-sensitive housing 120 may include presence-sensitive display 106 capable of receiving touch inputs from a user of computing device 102.

Presence-sensitive display 106 of UIC 110 may detect input (e.g., touch and non-touch input) from a user of respective computing device 102. For instance, presence-sensitive display 106 may detect indications of input by detecting one or more gestures from a user (e.g., the user touching, pointing, and/or swiping at or near one or more locations of presence-sensitive display 106 with a finger or a stylus pen). Presence-sensitive display 106 may output information to a user in the form of a user interface, which may be associated with functionality provided by computing device 102. Such user interfaces may be associated with computing platforms, operating systems, applications, and/or services executing at or accessible from computing device 102 (e.g., electronic message applications, chat applications, Internet browser applications, mobile or desktop operating systems, social media applications, electronic games, menus, and other types of applications).

UI module 114 of computing device 102 may manage user interactions with UIC 110 and other components of computing device 102. In other words, UI module 114 may act as an intermediary between various components of computing device 102 to make determinations based on user input detected by UIC 110 and generate output at UIC 110 in response to the user input. UIC module 114 may receive instructions from an application, service, platform, or other module of computing device 102 to cause UIC 110 to output a user interface. UI module 114 may manage inputs received by computing device 102 as a user views and interacts with the user interface presented at UIC 110 and may update the user interface in response to receiving additional instructions from the application, service, platform, or other module of computing device 102 that is processing the user input.

Computing device 102 may include UI module 114 and applications 118. UI module 114 and applications 118 may perform operations described using software, hardware, firmware, or a mixture of hardware, software, and/or firmware residing in and/or executing at computing device 102. Computing device 102 may execute UI module 114 and applications 118 with one or more processors. Computing device 102 may execute UI module 114 and applications 118 as a virtual machine executing on underlying hardware. UI module 114 and applications 118 may execute as services or components of an operating system or computing platform. UI module 114 and applications 118 may execute as one or more executable programs at an application layer of a computing platform. UI module 114 and applications 118 may be otherwise arranged remotely to and remotely accessible to computing device 102, for instance, as one or more network services operating at a network in a network cloud.

Applications 118 may execute at computing device 102 to perform any of a variety of operations. Examples of applications 118 include, but are not limited to, music applications, photo viewing applications, mapping applications, electronic message applications, chat applications, Internet browser applications, social media applications, electronic games, menus, and/or other types of applications that may operate based on user input.

In operation, applications 118 may cause UI module 114 to generate a graphical user interface (GUI) for display at UIC 110. UIC 110 may output a graphical user interface based on instructions from applications 118. In one example, applications 118 may include a photo viewing application that causes UI module 114 to generate a GUI including a picture of a mountain for display at UIC 110. In another example, applications 118 may include a web browser application that causes UI module 114 to generate a GUI including data associated with content of web pages loaded by the web browser.

A user may desire to provide user input to applications 118. For instance, where applications 118 may include a photo viewing application, the user may provide gesture input at UIC 110 in the form of a swipe gesture to swipe between photos of the photo viewing application or may provide gesture input at UIC 110 to select a photo album for viewing. Presence-sensitive display 106 may detect the gesture input. For instance, where presence-sensitive display 106 is a capacitive-touch panel, presence-sensitive display 106 may detect the gesture input via use of one or more capacitive touch sensors embedded in presence-sensitive housing 120.

Presence-sensitive housing 120 may completely or partially enclose the exterior of computing device 102 such that presence-sensitive housing 120 may detect user input at any point of the back (opposing side of computing device 102 from the side of display 106) and sides of the exterior of computing device 102. As an example, presence-sensitive housing 120 may detect touch input from a user but may not require physical contact between the user and presence-sensitive housing 120 to detect the user input. Presence-sensitive housing 120 may detect user input within a certain distance from presence-sensitive housing 120. Presence-sensitive housing 120 may be located on the sides, rear (side of computing device 102 opposing a display of computing device 102), and front of computing device 102. Presence-sensitive housing 120 may “wrap” around computing device 102 to enable the detection of user input at any point of the exterior of computing device 102. For example, presence-sensitive housing 120 may detect user touch input at any location along the back (i.e., the side of computing device 102 opposite that of display 106) or sides of computing device 102 via signals detected by one or more sensors 112.

Presence-sensitive housing 120, in the example of FIG. 1, may include one or more sensors 112 embedded in, disposed on, connected to, or otherwise associated with presence-sensitive housing 120. Sensors 112 (e.g., sensor 112A and/or sensor 112B) associated with presence-sensitive housing 120 may include pressure-sensitive sensors or buttons such as touch-sensitive buttons, force-sensitive resistors (FSRs), capacitive pressure sensors, piezoelectric sensors, Micro-Electro-Mechanical Systems (MEMS) sensors, tactile matrix sensors, resistive touch sensors, and/or other type of sensors or buttons for detecting gestures applied to presence-sensitive housing 120.

Computing devices may have limited ability to configure buttons or sensors to output customized user interface elements. For example, a volume button of a computing device may, in some computing devices, be configured to simply adjust an output volume of the computing device. Such computing devices may be limited in user interface experiences that may be output responsive to gestures detected by buttons or sensors of the computing devices. Computing device 102, according to the techniques described herein, may improve a user's experience interacting computing device 102 (e.g., interacting with applications 118, using computing device 102 to access physical resources, etc.) by triggering, responsive to a gesture and/or combination of gestures detected by a sensor (e.g., a combination of tactile inputs detected by a volume button) of one or more sensors 112, the output of contextual user interface elements configured with user interface controls determined based on contextual signals associated with computing device 102. In other words, computing device 102 may improve functionality of computing device 102 by performing actions (e.g., outputting contextual user interface elements) based on contextual signals of computing device 102 and responsive to one or more gestures detected by a sensor of sensors 112 (e.g., a volume button).

In accordance with the techniques described herein, computing device 102 may output a user interface element configured with a contextual user interface control. Contextual UI controller 116 of computing device 102 may include computer readable instructions for determining a context associated with computing device 102 and/or selecting a user interface control based on a determined context. For example, contextual UI controller 116 may collect contextual signals associated with computing device 102. For example, in response to receiving a user's explicit consent, computing device 102 may collect data associated with one or more of: a phone state of computing device 102 (e.g., data indicating a current power source capacity, data indicating external devices connected via wireless communication devices, etc.), an application state of applications 118 that may be executed by computing device 102 (e.g., display data generated by a software application and output via display 106, user input data detected by display 106 when a user is interacting with a software application, etc.), an environmental state of computing device 102 (e.g., data collected by additional sensors of one or more sensors 112), and/or a state associated with functionality and operation of computing device 102. For example, an environmental state might include the ambient light level, the device's location, or the current temperature.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. For example, UI module 114 may generate data for a graphical user interface that allows a user to configure privacy settings associated with computing device 102 collecting contextual signals. UI module 114 may output the data for the graphical user interface via display 106. UI module 114 may store user privacy preferences (e.g., configurations associated with collecting contextual signals) at a storage device of computing device 102. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Contextual UI controller 116 may determine a context associated with computing device 102 based on collected contextual signals. For example, contextual UI controller 116 may determine a context associated with computing device 102 as a state of computing device 102 (e.g., a phone state, an application state, and/or an environmental state of computing device 102 determined at a time when a gesture is detected by a sensor of one or more sensors 112). For example, contextual UI controller 116 may determine a context associated with a user is intending to capture an image based on accelerometer data indicating the user has raised computing device 102 (e.g., a “raise to wake” or “raise to capture” motion). In another example, contextual UI controller 116 may determine a context associated with a user is in a specific commercial location (e.g., a grocery store, retail warehouse, etc.). In some examples, contextual UI controller 116 may determine a context associated with computing device 102 using one or more machine learning models trained to determine the context of computing device 102 based on contextual signals collected by contextual UI controller 116. In one example, contextual UI controller 116 may implement clustering techniques to cluster contextual signals to identify one or more clusters corresponding to respective one or more contexts associated with computing device 102. In some instances, contextual UI controller 116 may apply machine learning techniques to determine a frequency to determine one or more contexts associated with computing device 102 in order to reduce latency and/or reduce computational resource consumption associated with determining the one or more contexts prior to outputting a contextual user interface element configured with one or more user interface controls selected based on the determined one or more contexts.

Contextual UI controller 116 may select one or more user interface controls from a plurality of user interface controls based on one or more determined contexts associated with computing device 102. For example, contextual UI controller 116 may select a user interface control mapped to a context corresponding to a threshold (e.g., a threshold number of contextual signals, a confidence threshold associated with generating context clusters of contextual signals, etc.). In some examples, contextual UI controller 116 may select a user interface control based on rule-based or hierarchical approaches associated with one or more determined contexts associated with computing device 102. For example, contextual UI controller 116 may maintain configurations indicating rules for selecting and/or ordering a set of user interface controls based on respective determined context (e.g., a rule to select and prioritize a first user interface control, mapped to a first context cluster, over a second user interface control selected based on a second context cluster).

Contextual UI controller 116 may output a contextual user interface element configured with a selected user interface control. Contextual UI controller 116 may output a contextual user interface element configured with a contextual user interface control responsive to a sensor of one or more sensors 112 detecting a particular gesture. In one example, in instances where sensor 112A is a volume button, sensor 112A may detect a sequence of one or more gestures 152A (also referred to as “gestures 152A”) (e.g., tactile inputs such as a touch, a press, a fling, a drag, a force press such as a press exceeding a pressure threshold, or any combination thereof). Sensor 112A may send contextual UI controller 116 an indication of detected gestures 152A. In response to receiving the indication of gestures 152A, contextual UI controller 116 may output contextual user interface (UI) element 128A that is configured with a user interface control selected based on a determined context associated with computing device 102. For example, responsive to receiving gestures 152A including a combination of two presses to sensor 112A, contextual UI controller 116 may use UI module 114 to generate and output data for contextual UI element 128 that is configured with a user interface control selected based on a determined context of computing device 102.

In another example, in instances where sensor 112B is a capacitive sensing sensor, sensor 112B may detect gesture 152B (e.g., tactile inputs such as a touch, a press, a fling, a drag, or any combination thereof). Sensor 112B may send contextual UI controller 116 an indication of detected gesture 152B. In response to receiving the indication of gesture 152B, contextual UI controller 116 may output contextual user interface (UI) element 128B that is configured with a user interface control selected based on a determined context associated with computing device 102.

In operation, contextual UI controller 116 may send, responsive to receiving an indication of a particular gesture applied to a sensor of one or more sensors 112, UI module 114 one or more user interface controls selected based on one or more respective contexts determined for computing device 102. UI module 114 may generate data for a contextual user interface element (e.g., contextual user interface element 128A or contextual user interface element 128B) as data for a graphical user interface configured with the selected one or more interface controls. UI module 114 may output, for display at display 106, data for the contextual user interface element that is configured with functionality of the selected one or more user interface controls. UI module 114 may output the contextual user interface element configured with the one or more selected one or more user interface controls for display at a portion of display 106 associated with the sensor that detected the particular gesture.

The portion of display 106 associated with the sensor may include a dedicated area (e.g., a dock) of display 106 that may not be obstructed by a user operating computing device 102 (e.g., the portion of display 106 being a small area on a side of display 106 such that a user may view the contextual user interface element when interacting with other areas of display 106). In some instances, the portion of display 106 associated with the sensor may improve accessibility of a user operating computing device 102. For example, UI module 114 may output a contextual user interface element in a portion of display 106 that allows a user to easily interact with the contextual user interface element and/or display data displayed at display 106 using a single hand. UI module 114 may, in some examples, provide users, e.g., via a settings user interface, the ability to configure where the portion of display 106 associated with a sensor of one or more sensors 112 is located at display 106.

The techniques of this disclosure include one or more advantages. For example, computing device 102 may improve information output, via display 106, to a user operating computing device 102 responsive to a gesture applied to a sensor of computing device 102. By computing device 102 outputting graphical user interface elements configured with user interface controls that are selected based on contextual signals collected by computing device 102, computing device 102 may output contextually relevant information (e.g., data associated with an application state of an application executed by computing device 102), perform contextually relevant actions (e.g., unlock access to physical resources based on a location indicated in an environmental state of computing device 102), and/or execute other contextually relevant tasks (e.g., adjust an output volume of computing device 102, adjust a screen brightness of computing device 102, send signals to external devices connected to computing device 102, etc.). Computing device 102 may output contextual user interface elements for display at designated portions of display 106 to improve a user's flow interacting with computing device 102 (e.g., outputting the contextual user interface element for display at a portion of display 106 that is unobstructed and/or unobtrusive when a user is interacting with content displayed at computing device 102). In this way, computing device 102 may improve a user's experience interacting with computing device 102 by at least providing contextually relevant information or actions responsive to sensor inputs and/or providing the contextually relevant information or actions in a way that improves accessibility associated with interacting with computing device 102 (e.g., improving accessibility of using computing device 102 with one hand, improving accessibility of display data output via display 106, etc.).

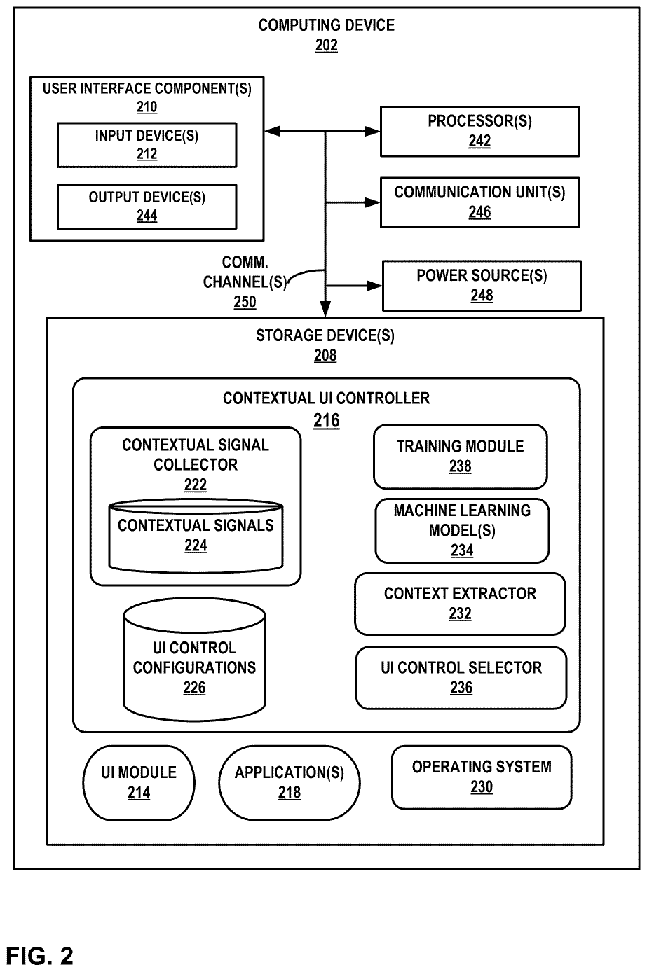

FIG. 2 is a block diagram illustrating example computing device 202 for outputting user interface elements with contextual user interface controls, in accordance with one or more techniques of this disclosure. Computing device 202, user interface component(s) 210 (UIC 210), input device(s) 212, contextual user interface (UI) controller 216, user interface (UI) module 214, and application(s) 218 of FIG. 2 may be example or alternative implementations of computing device 102, UIC 110, one or more sensors 112, contextual UI controller 116, UI module 114, and applications 118 of FIG. 1, respectively.

As shown in FIG. 2, computing device 202 may include one or more user interface components 210 (“UIC 210”), one or more processors 242 (“processor 242”), one or more communication units 246 (“communication unit 246”), one or more power sources 248 (“power source 248”), and one or more storage devices 208 (“storage device 208”). Communication channels 250 (“COMM channel 250”) may interconnect each of the components 210, 242, 246, 248, and 208 for inter-component communications (physically, communicatively, and/or operatively). In some examples, communication channel 250 may include a system bus, a network connection, an inter-process communication data structure, or any other method for communicating data.

Also shown in FIG. 2, UIC 210 may include one or more input devices 212 (“input devices 212” or “sensor 212”) and one or more output devices (“output devices 244” or “display 244”). Input device 212 of computing device 202 may receive input. Examples of input are tactile, audio, and video input. Input device 212 of computing device 202, in one example, includes a capacitive pressure sensor, a touch-sensitive button, a Force-Sensitive Resistor (FSR), a piezoelectric sensor, a presence-sensitive display, a fingerprint sensor, touch-sensitive screen, mouse, keyboard, voice responsive system, video camera, microphone or any other type of device for detecting input from a human or machine.

Input devices 212 may additionally include one or more environmental sensors. Numerous examples of environmental sensors exist and include any input component configured to obtain data about the circumstances surrounding computing device 202 and/or physiological information that defines the activity state and/or physical well-being of a user of computing device 202. In some examples, an environmental sensor may be an input component that obtains physical position, movement, and/or location information of computing device 202. For instance, environmental sensors may include one or more location sensors (e.g., GNSS components, Wi-Fi components, cellular components), one or more temperature sensors, one or more motion sensors (e.g., multi-axial accelerometers, gyros), one or more pressure sensors (e.g., barometer), one or more ambient light sensors, and one or more other sensors (e.g., microphone, camera, infrared proximity sensor, hygrometer, and the like). Other environmental sensors may include a heart rate sensor, magnetometer, glucose sensor, hygrometer sensor, olfactory sensor, compass sensor, step counter sensor, to name a few other non-limiting examples.

Output device 244 of computing device 202 may generate one or more outputs. Examples of outputs are tactile, audio, and video output. Output device 244 of computing device 202, in one example, includes a presence-sensitive display, sound card, video graphics adapter card, speaker, liquid crystal display (LCD), or any other type of device for generating output to a human or machine.

Communication unit 246 of computing device 202 may communicate with one or more external devices via one or more wired and/or wireless networks by transmitting and/or receiving network signals on the one or more networks. Examples of communication units 246 include a network interface card (e.g., such as an Ethernet card), an optical transceiver, a radio frequency transceiver, a GNSS receiver, or any other type of device that can send and/or receive information. Other examples of communication unit 246 may include short wave radios, cellular data radios (for terrestrial and/or satellite cellular networks), wireless network radios, as well as universal serial bus (USB) controllers.

Power source 248 may provide power to one or more components of computing device 202. In some examples, power source 248 may be a battery. Power source 248 may provide power to components 210, 242, 246, and 208 of computing device 202, for example. Examples of power source 248 may include, but are not necessarily limited to, batteries having zinc-carbon, lead-acid, nickel cadmium (NiCd), nickel metal hydride (NiMH), lithium ion (Li-ion), and/or lithium polymer (Li-Po) chemistries. In some examples, power source 248 may have a limited capacity (e.g., 1000-3000 mAh). In some instances, power source 248 includes power provided via a socket.

Processor 242 may implement functionality and/or execute instructions within computing device 202. For example, processor 242 may receive and execute instructions that provide the functionality of modules 216, 214, 218, and Operating System (“OS”) 230. These instructions executed by processor 242 may cause computing device 202 to store and/or modify information within storage device 208 or processor 242 during program execution. Processor 242 may execute instructions of modules 216, 214, 218, and OS 230 to perform one or more operations. That is modules 216, 214, 218, and OS 230 may be operable by processor 242 to perform various functions described herein.

Storage device 208 within computing device 202 may store information for processing during operation of computing device 202 (e.g., computing device 202 may store data accessed by modules 216, 214, 218, and OS 230 during execution at computing device 202). In some examples, storage device 208 may be a temporary memory, meaning that a primary purpose of storage device 208 is not long-term storage. Storage device 208 on computing device 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage device 208 may include one or more computer-readable storage media. Storage device 208 may be configured to store larger amounts of information than volatile memory. Storage device 208 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Storage device 208 may store program instructions and/or information associated with modules 216, 214, 218, and OS 230.

Computing device 202 may include OS 230. OS 230 may control the operation of components of computing device 202. For example, OS 230 may facilitate the communication of modules 216, 214, and 218 with processor 242, storage device 208, and communication units 246. In some examples, OS 230 may manage interactions between software applications (e.g., application 218) and a user of computing device 202. OS 230 may have a kernel that facilitates interactions with underlying hardware of computing device 202 and provides a fully formed application space capable of executing a wide variety of software applications having secure partitions in which each of the software applications executes to perform various operations. In some examples, UI module 214 may be considered a component of OS 230.

In accordance with the techniques described herein, contextual UI controller 216 may output contextual user interface elements configured with contextual user interface controls. Contextual UI controller 216, in the example of FIG. 2, may include contextual signal collector 222, user interface (“UI”) control configurations 226, context extractor 232, one or more machine learning models 234, training module 238, and user interface (“UI”) control selector 236. Contextual signal collector 222 may monitor and collect, with explicit permission from a user operating computing device 202, contextual signals as data indicating states associated with computing device 202. For example, contextual signal collector 222 may collect data indicating a phone state (e.g., data associated with processor 242, communication unit 246, power source 248, etc.), data indicating an application state (e.g., data associated with applications 218, data displayed via output device 244, etc.), data indicating an environmental state (e.g., data obtained using any of UIC 210), or other data indicating other states associated with computing device 202. Contextual signal collector 222 may store obtained contextual signals as contextual signals 224.

Context extractor 232 may include computer readable instructions for determining one or more contexts associated with computing device 202 based on contextual signals 224. Context extractor 232 may implement any combination of thresholds, clustering techniques, machine learning techniques, rule-based techniques, hierarchical based techniques, and/or other prediction-based techniques to process contextual signals 224 and determine one or more contexts associated with computing device 202. For example, context extractor 232 may implement machine learning models 234 to analyze contextual signals 224 for user interface control predictions. Machine learning models 234 may include one or more traditional machine learning models (e.g., predictive model, classification model, etc.) and/or one or more generative machine learning models (e.g., transformer models such as large language models). Training module 238 may train, re-train, fine-tune, or otherwise adjust parameters associated with machine learning models 234. For example, training module 238 may use sample contextual signals labeled with ground truth user interface controls to train a machine learning model of machine learning models 234 to predict a user interface control based on the sample contextual signals. Training module 238 may use any combination of sample data such as foundational, labeled learning data, application data of applications 218 (e.g., data obtained via application programming interfaces associated with applications 218), or other types of training data for context determinations associated with computing device 202.

Context extractor 232 may provide contextual signals 224 to a machine learning model of machine learning models 234 to determine one or more contexts associated with computing device 202. Context extractor 232 may employ a machine learning model of machine learning models 234 that includes biases and weights associated with various types and attributes of contextual signals stored at contextual signals 224. The machine learning model may include weights and biases assigned to data indicating contextual signals stored as contextual signals 224 to determine which contextual signals of contextual signals 224 to use for context determinations. For instance, the machine learning model may prioritize, based on weights and biases associated with data indicating contextual signals, contextual signals associated with an application state of computing device 202 over contextual signals associated with an environmental state associated with computing device 202. Training module 238 may adjust the weights and biases of the machine learning model based on feedback data (e.g., subsequent user inputs detected via input devices 212) and/or additional contextual signals. The machine learning model may be trained using supervised, unsupervised, or reinforcement learning techniques, and may be updated periodically to improve its accuracy and adapt to changing user behavior.

In some examples, context extractor 232 may determine one or more contexts associated with computing device 202 by generating clusters of contextual signals collected within a time period. For example, context extractor 232 may identify a set of contextual signals of contextual signals 224 with timestamps indicating that the set of contextual signals were obtained within a time period. Context extractor 232 may generate, based on the identified set of signals, one or more clusters that each indicate groupings of the identified set of contextual signals. Context extractor 232 may identify one or more contexts associated with computing device 202 by, for example, selecting one or more clusters of the generated clusters based on a volume threshold of contextual signals within corresponding clusters (e.g., determine top-N clusters that have a greater number of contextual signals), a priority list associated with the clusters and/or contextual signals, thresholds associated with the clusters and/or contextual signals, or other types of rules that may be implemented for context determinations. Context extractor 232 may identify the one or more contexts based on configuration data of user interface (“UI”) control configurations 226 indicating the selected one or more clusters correspond to the one or more contexts (e.g., configuration data indicating that a selected cluster of contextual signals including display data associated with a software application corresponds to a context of an application state associated with the software application). Context extractor 232 may send the identified, selected one or more contexts to UI control selector 236.

In some instances, context extractor 232 may determine how many contexts to output to UI control selector 236 based on contextual signals 224. Context extractor 232 may analyze data indicating a phone state (e.g., data indicating a current power capacity associated with power source 248, data indicating whether processor 242 is operating in low-power mode, e.g. a mode in which the processor operates at a reduced clock speed or with fewer cores active to conserve energy, data indicating external devices in communication with communication unit 246, image data captured via UIC 210, marketing data associated with data output via UIC 210, etc. to determine a number of contexts to use for user interface control selection. For instance, based on data indicating that power source 248 has a low current capacity, context extractor 232 may determine a single context associated with computing device 202 to potentially conserve computational resources associated with analyzing contextual signals 224 for context determinations.

UI control selector 236 may select one or more user interface controls corresponding to one or more contexts output by context extractor 232. UI control selector 236 may select a user interface control from a plurality of user interface controls based on configuration data stored at UI control configurations 226. UI control configurations 226 may include configuration data indicating mappings of user interface controls to contexts (e.g., graph data structures indicating correlations between user interface controls and clusters of contextual signals). For example, UI control configurations 226 may include configuration data for a user interface control that is mapped to a context indicating a particular state associated with computing device 202. UI control selector 236 may select the user interface control mapped to the context based on receiving an indication of the context from context extractor 232. UI control selector 236 may select a number of user interface controls based on a number of user interface controls mapped to one or more contexts determined and output by context extractor 232. In instances where there are no user interface controls mapped to the one or more determined contexts associated with computing device 202, UI control selector 236 may select a default user interface control specified in configuration data of UI control configurations 226.

UI control configurations 226 may include a combination of manually entered and automatically generated configuration information for user interface control to context mappings. For example, UI module 214 may output data for a settings user interface that allows a user operating computing device 202 to enable, disable, or otherwise define contextual user interface controls to be selected and output as part of a contextual user interface element responsive to one or more determined contexts. In some examples, applications 218 may be associated with application programming interfaces (APIs) that include user interface control configuration information indicating context to user interface control mappings. UI module 214 may output data for a settings user interface that allows a user operating computing device 202 to enable, disable, or otherwise modify user interface control configuration information executed via APIs associated with applications 218.

UI control configurations 226 may include automatically generated configuration information indicating user interface control to context mappings. For example, a machine learning model of machine learning models 234 may collect, with express consent from a user operating computing device 202, data indicating actions initiated by the user during a time one or more contexts are determined by context extractor 232. The machine learning model may generate or identify one or more contextual user interface elements configured with one or more contextual user interface controls based on a behavior ascertained according to the collected data indicating actions initiated by the user. For instance, the machine learning model may analyze the collected data to identify that the user uses communication unit 246 to activate an external device during a time context extractor 232 determines computing device 202 is at a particular environmental state (e.g., in a particular location a certain distance from the external device). The machine learning model may generate a contextual user interface element configured with a contextual user interface control for activating the external device in the future, when the particular environmental state is determined to be a context associated with computing device 202. UI module 214 may generate data for a user interface requesting a user operating computing device 202 to enable outputting the contextual user interface element configured with the contextual user interface control for activating the external device based on the particular environmental state context.

In response to receiving a request to enable a contextual user interface element that is configured with a contextual user interface control, UI module 214 may output data for a graphical user interface for a user to provide a gesture that may trigger the output of the user interface element and control responsive to a determination and/or selection of one or more contexts associated with the request to enable the contextual user interface element with the contextual user interface control. For example, responsive to receiving a request to enable an automatically generated user interface element and/or user interface control, contextual UI controller 216 may record a gesture detected using input device 212 (e.g., record a combination of tactile inputs, such as a long press followed by a swipe up gesture, applied to a volume button). Contextual UI controller 216 may save configuration data for a gesture by assigning the gesture to a user interface control mapped to one or more contexts.

In some instances, a machine learning model of machine learning models 234 may determine a time interval indicating when and/or how often context extractor 232 is to determine contexts associated with computing device 202. For example, the machine learning model may collect, responsive to explicit consent from a user operating computing device 202, data indicating how often input device 212 detects a gesture that triggers the output of a contextual user interface. The machine learning model may determine a time interval for determining a context associated with computing device 202 by at least predicting, based on the collected data, how often the user provides a triggering gesture. For example, the machine learning model may determine that the user provides a first gesture associated with triggering the output of a first set of contextual user interfaces mapped to a first set of contexts every two hours. In another example, the machine learning model may determine that a user operating computing device 202 provides a second gesture associated with triggering the output of a second set of contextual user interfaces mapped to a second set of contexts approximately every 15 minutes between 9:00 AM and 5:00 PM. The machine learning model may output instructions for context extractor 232 to analyze contextual signals associated with a set of contexts (e.g., the first set of contexts associated with the first gesture, the second set of contexts associated with the second gesture, etc.) according to a time interval (e.g., every two hours, every 15 minutes between 9:00 AM and 5:00 PM, etc.) associated with an identified behavior of the user requesting contextual user interfaces for the set of contexts. In this way, the machine learning model may conserve computational resources (e.g., power consumption, processing cycles, memory usage, etc.) associated with continuously analyzing each signal of contextual signals 224 to continuously determine a context associated with computing device 202. Additionally or alternatively, the machine learning model may reduce latency associated with outputting contextual user interfaces by predicting how often and/or when a user operating computing device 202 requests contextual user interfaces via gestures detected using input device 212.

UI control selector 236 may use UI module 214 to output a graphical user interface element configured with a contextual user interface control selected by UI control selector 236. For example, responsive to input device 212 detecting a gesture associated with triggering an output of the contextual user interface control, UI control selector 236 may send UI module 214 data associated with the user interface control. UI module 214 may generate data for a contextual user interface element as a graphical user interface element (e.g., by populating data of a contextual user interface element template based on contextual signals, data obtained via a network, artificially generated data, retrieved data, etc.) that is configured with the selected user interface control. UI module 214 may output the data for the contextual user interface for display via output device 244. UI module 214 may send instructions to output device 244 to output the contextual user interface in a portion of output device 244 designated or otherwise associated with the sensor of input device 212 that detected the gesture. In some instances, contextual UI controller 216 may output contextual user interfaces based on default gestures detected using input device 212 (e.g., a combination of tactile inputs applied to a sensor of input device 212).

In some examples, training module 238 may further train, re-train, and/or fine-tune machine learning models 234 based on feedback data obtained using input device 212. Training module 238 may adjust parameters, weights, biases, etc. of machine learning models 234 based on user inputs indicating a preferred user interface control given particular contextual signals. For example, training module 238 may decrease weights associated with contextual signals indicating a particular environmental state (e.g., contextual signals indicating an increased heart rate) based on user inputs indicating numerous dismissals of a user interface control (e.g., changing or canceling the user interface control) that has been output based on a determination of a context associated with the particular environmental state and responsive to a gesture. In some instances, training module 238 may automatically adjust configuration data (e.g., user interface control to context mappings) based on feedback data obtained using input device 212. For example, training module 238 may change, at UI control configurations 226, a mapping of a user interface control to a first context to be a mapping of the user interface control to the first context and a second context based on feedback data indicating that the user interface control was utilized by a user operating computing device 202 responsive to a determination of the first context and the second context. In some examples, UI module 214 may generate and output data for a graphical user interface requesting feedback from a user operating computing device 202 to collect feedback data associated with performance of contextual UI controller 216 determining contexts and/or selecting corresponding user interface controls.

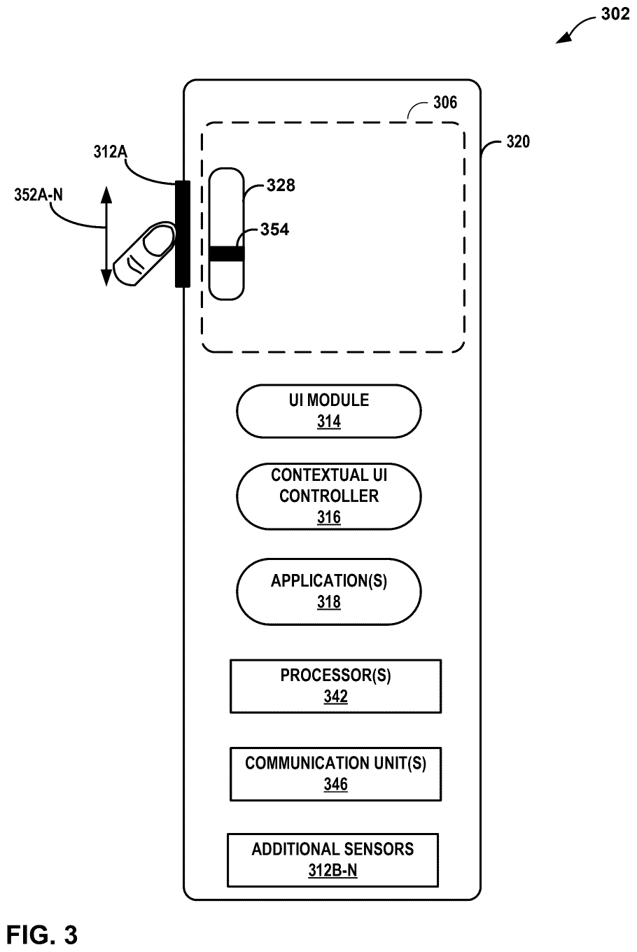

FIG. 3 is a conceptual diagram illustrating example computing device 302 including example user interface element 328 with example user interface control 354, in accordance with one or more techniques of this disclosure. Computing device 302, housing 320, display 306, sensors 312, gestures 352A-352N, user interface (UI) module 314, contextual user interface (UI) controller 316, user interface element 328, and applications 318 of FIG. 3 may be example or alternative implementations of computing device 102, presence-sensitive housing 120, presence-sensitive display 106, sensors 112, gestures 152, UI module 114, contextual UI controller 116, user interface elements 328, and applications 118 of FIG. 1, respectively. Computing device 302, display 306, sensors 312A-312N, UI module 314, contextual UI controller 316, applications 318, one or more processors 342, and one or more communication units 346 of FIG. 3 may be example or alternative implementations of computing device 202, output device 244, input device 212, UI module 214, contextual UI controller 216, applications 218, processors 242, and communication unit 246 of FIG. 2, respectively.

Computing device 302 may output contextual user interface element 328 to include graphical data associated with functionality of contextual user interface control 354. In the example of FIG. 3, computing device 302 may output contextual user interface element 328 as a slider element configured with contextual user interface control 354 associated with adjusting a slider value of the slider element and performing a corresponding action. Contextual UI controller 316 may, according to the techniques described herein, determine a context associated with computing device 302 and select contextual user interface control 354 based on the determined context. For instance, contextual UI controller 316 may collect and analyze contextual signals indicating a state of computing device 302. Contextual UI controller 316 may process the contextual signals to determine a context associated with computing device 302 that includes one or more indications of states associated with computing device 302. Contextual UI controller 316 may select contextual user interface control 354 based on user interface control configuration data indicating that contextual user interface control 354 corresponds to the determined context associated with computing device 302. In general, contextual UI controller 316 may select contextual user interface control 354 as a user interface control that includes computer readable instructions for executing an action (e.g., adjusting slider values of a slider user interface element, adjusting output parameters of computing device 302, outputting contextually relevant information, executing application-specific actions and controls, etc.) contextually related to a state indicated in a context determined for computing device 302.

In one example, contextual UI controller 316 may determine, based on contextual signals indicating a state of computing device 302, that a context of computing device 302 indicates a phone state associated with low battery (e.g., low capacity of a power source of computing device 302). Contextual UI controller 316 may select contextual user interface control 354 as a user interface control for adjusting an output setting of computing device 302 (e.g., adjusting screen brightness of display 306, adjusting an output volume of computing device 302, adjusting a camera zoom level, adjusting a camera ISO setting, adjusting a camera white balance setting, switching between low power modes associated with one or more processors 342, etc.) based on the context indicating the phone state of computing device 302 is associated with low battery. In this way, contextual UI controller 316 may predict that a user would want to conserve computational resources associated with computing device 302 and output one or more user interface controls enabling the user to quickly and efficiently reduce or adjust power consumption of computing device 302.

In another example, contextual UI controller 316 may determine a context associated with computing device 302 indicating an application state, associated with display data output by display 306, of browsing a webpage via a web browser application. Contextual UI controller 316 may select, based on the context indicating the application state associated with the webpage, contextual user interface control 354 as a user interface control for scrolling through contents of the webpage displayed at display 306.

In another example, contextual UI controller 316 may determine a context associated with computing device 302 indicating an environmental state associated with data obtained using one or more of additional sensors 312B-312N. For instance, contextual UI controller 316 may determine a context associated with computing device 302 that indicates an environmental state associated with an acceleration or speed determined for computing device 302 based on an accelerometer of additional sensors 312B-312N, an atmospheric pressure determined based on a barometer of additional sensors 312B-312N, a biometric state detected by health sensors of additional sensors 312B-312N (e.g., a biometric state of a high heart rate, a biometric state of high blood pressure, a biometric state of high blood sugar, etc.) and/or a location of computing device 302. Contextual UI controller 316 may select, based on the context indicating the environmental state, contextual user interface control 354 as a user interface control mapped to the context indicating the environmental state. For example, contextual UI controller 316 may select, based on the context of computing device 302 indicating an environmental state associated with computing device 302 being a threshold distance from an external device, contextual user interface control 354 as a user interface control for adjusting settings associated with the external device (e.g., adjusting outputting settings of the external device such as adjusting a volume setting of an external speaker, adjusting a brightness setting of an external light source, etc.) in a way that corresponds to the slider value displayed at contextual user interface element 328.

Contextual UI controller 316 may, responsive to receiving an indication a user provided one or more gestures 352, output contextual user interface element 328 configured with contextual user interface control associated with a selected user interface control (e.g., a selected user interface control of adjusting output settings of computing device 302, a selected user interface control of scrolling through images displayed via display 306, etc.). In some examples, contextual UI controller 316 may output contextual user interface control 354 as a default user interface control (e.g., a user interface control to adjust a volume output by computing device 302) based on, for example, a determination that no user interface control is mapped to a determined context responsive to a user providing one or more gestures 352. Computing device 302 may execute user interface control 354 based on tactile inputs provided at sensor 312A. For example, computing device 302 may adjust a slider value of user interface control 354 based on tactile inputs (e.g., subsequent gestures) applied to sensor 312A after contextual user interface element 328 is output via display 306. Computing device 302 may perform an action based on changes to the slider value. For example, computing device 302 may adjust an output setting of computing device 302 based on an increase or decrease to the slider value, update data displayed via display 306 (e.g., moving through content displayed at display 306, scroll through a webpage, scroll through images, etc.) based on an increase or decrease to the slider value, adjust settings of an external device in communication with computing device 302 via communication unit 346 e.g., adjust brightness settings of an external smart light fixture connected to computing device 302 based on changes to the slider value), or any other customizable gesture-control actions associated with components of computing device 302. In some examples, in response to sensor 312A detecting a second gesture (i.e., gestures 452 precede the second gesture), contextual UI controller 316 may select and output a contextual user interface element configured with a contextual user interface control selected from a stack of contextual user interfaces.

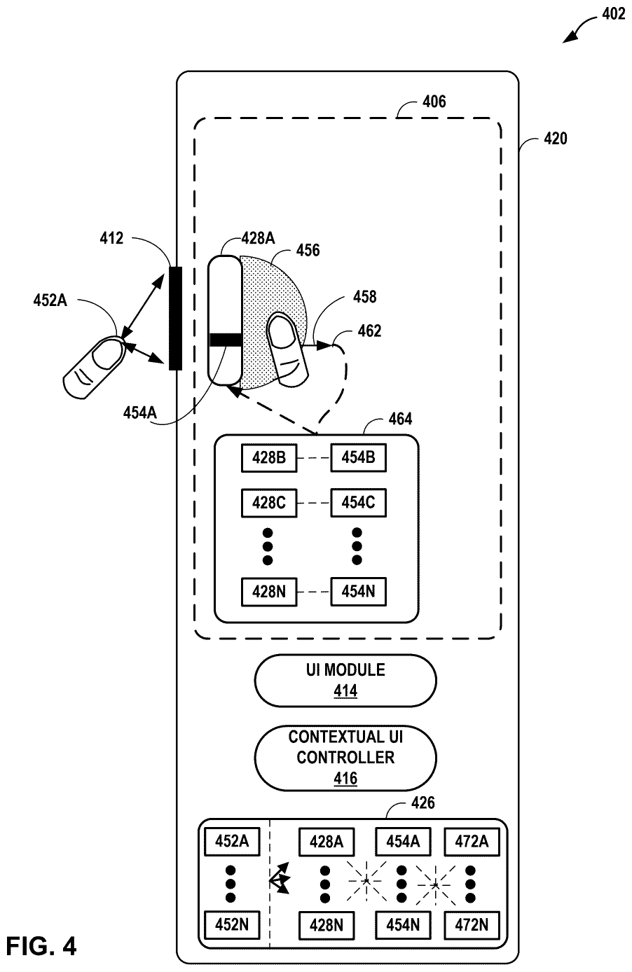

FIG. 4 is a conceptual diagram illustrating example gestures 452 for switching between example user interface controls 454, in accordance with one or more techniques of this disclosure. Computing device 402, housing 420, display 406, gestures 452A-452B, sensor 412, contextual UI controller 416, UI module 414, contextual user interface elements 428A-428N, and contextual user interface controls 454A-454N of FIG. 4 may be alternative or example implementations of computing device 302, housing 320, display 306, gestures 352, sensor 312A, contextual UI controller 316, UI module 314, contextual user interface element 328, and contextual user interface control 354 of FIG. 3, respectively.

Contextual UI controller 416 may determine multiple contexts 472 associated with collected contextual signals. In some instances, contexts of contexts 472 may indicate one or more states associated with computing device 402 and/or correspond to one or more clusters of contextual signals mapped to contextual user interface controls 454 of user interface (“UI”) control information 426. In one example, contextual UI controller 416 may determine context 472A associated with an application state (e.g., an application state indicating a video or other media is displayed via display 406) and context 472B associated with an environmental state (e.g., an environmental state indicating loud interference or other noise surrounding computing device 402). In some examples, stack of user interfaces 464 may be displayed or otherwise presented as a “drawer” or “slice” of mini-applications (e.g., application slices). For instance, responsive to a gesture (e.g., a force press or a fling), computing device 402 may output a drawer containing condensed controls for multiple applications (e.g., a translation slice, a wallet slice, a task slice, a music player slice, etc.), which may allow a user to interact with multiple applications without fully launching the multiple applications Contextual UI controller 416 may, for example, determine context 472A and context 472B based on clusters of contextual signals identified to be above a confidence threshold. In instances where no clusters of contextual signals satisfy a confidence threshold, contextual UI controller 416 may select a default user interface control from UI controls 454A-454N. In instances where a first cluster corresponding to context 472A and a second cluster corresponding to context 472B satisfy the confidence threshold, contextual UI controller 416 may select stack of user interfaces 464 as an ordered list of pairs of user interface elements 428 and user interface controls 454 selected from UI controls 454A-454N based on UI control configuration information 426 indicating the pairs of user interface elements 428 and user interface controls 454 are mapped to context 472A and/or context 47B. In some examples, contextual UI controller 416 may select stack of user interfaces 464 based on a single determined context (e.g., context 472A).

Additionally or alternatively, contextual UI controller 416 may implement a “stash” functionality. For instance, responsive to a gesture (e.g., a long press or force press) while a user is viewing content on display 406, computing device 402 may capture current screen content (e.g., a screenshot or selected text) and “stash” it into a contextual storage. Computing device 402 may, responsive to a user subsequently performing a retrieval gesture, determine a current context and may surface “stashed” items in contextual user interface element 428. For instance, if a user stashes one or more receipt images and later opens a budgeting application, contextual user interface 428 may automatically surface the one or more stashed receipt images.

In response to receiving an indication of gesture 452A, contextual UI controller 416 may determine which user interface control from stack of user interface controls 464 to output based on priorities, thresholds, or other rules associated with UI control configuration data 426. For example, UI control configuration data 426 may include policies indicating a hierarchy or other rule based approaches associated ranks for mappings of user interface controls 454 to user interface elements 428. For example, contextual UI controller 416 may order user interface control 454A and each user interface control of stack of user interfaces 464 identified based on user interface controls mapped to the first context and the second context determined by contextual UI controller 416 according to a hierarchy indicated in UI control configuration data 426. Contextual UI controller 416 may output contextual user interface element 428A configured with contextual user interface control 454A based on the contextual user interface element 428A, contextual user interface control 454A pair being ranked higher than other user interface element, user interface control pairs indicated in stack of user interfaces 464. In some instances, contextual UI controller 416 may rank user interface controls 454 based on default parameters and/or parameters offered and selected by a user operating computing device 402.

UI control configuration data 426 may include configurable data structures associated with generating and outputting contextual user interfaces. For example, UI control configuration data 426 may include data structures that map, index, or otherwise assign indications of gestures 452A-452N to contextual user interface elements 428A-428N and/or contextual user interface controls 454A-454N. UI control configuration data 426 may include a set of rules for outputting contextual user interfaces. For example, UI control configuration data 426 may include rules indicating which set of user interface control and user interface element pairs to select based on contextual signals indicating a particular set of contexts of contexts 472 mapped to respective user interface control and user interface element pairs.

Contextual UI controller 416 may update rules, weights, biases, thresholds, hierarchies, ranks, or other aspects of UI control configuration data 426 based on feedback data associated with user inputs obtained in response to outputting a contextual user interface element, contextual user interface control pair based on a current state of UI control configuration data 426. Feedback data associated with user inputs obtained responsive to outputting a contextual user interface element, contextual user interface control pair may include an indication of user input 458 associated with changing the user interface element, user interface control pair currently displayed via display 406.

In response to receiving an indication of user input 458, contextual UI controller 416 may use UI module 414 to generate and output data for an alternative user interface element, user interface control pair of stack of user interfaces 464. For example, in response to receiving an indication of user input 458—where gestures 452A precedes user input 458—as a swipe right gesture within portion 456 of display 406 that is associated with sensor 412, contextual UI controller 416 may instruct UI module 414 to generate and output user interface element 428B (e.g., a preview of images, a preview of icons associated with software application executed by computing device 402, etc.) configured with user interface control 454B (e.g., scrolling through content displayed via display 406, scrolling through content displayed via a corresponding user interface element, etc.). In general, responsive to receiving an indication of user input 458, contextual UI controller 416 may instruct UI module 414 to output, for display via display 406, updated user interface 462 including an updated user interface element (e.g., a slider element, a graphical element populated with contextual data, etc.) configured with an updated user interface control (e.g., adjusting an output setting of computing device 402, moving through content displayed via display 406, selecting an icon displayed in contextual data of the user interface element, capturing content displayed in a portion of display 406, outputting contextually related images via display 406, etc.). In some instances, contextual UI controller 416 may instruct UI module 414 to generate and output data for updated user interface 462 based on a contextual user interface element, contextual user interface control pair determined based on one or more contexts of computing device 402 and/or rules ordering user interface element, contextual user interface control pairs that are mapped to the one or more contexts. In some examples, contextual UI controller 416 may limit a number of user interface controls within stack of user interfaces 464 based on computational resource constraints (e.g., processing restraints, memory restraints, low power, etc.).

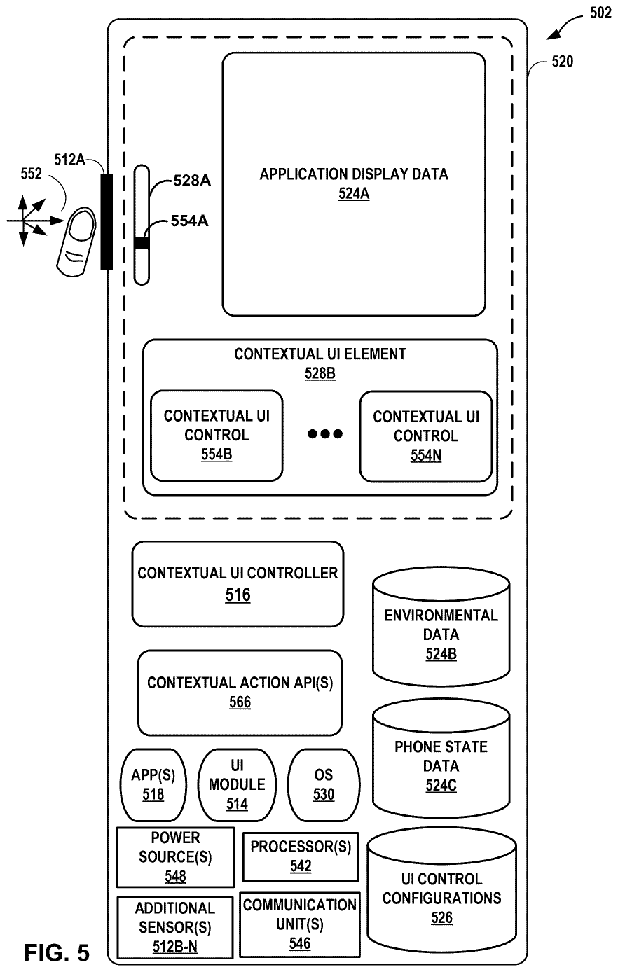

FIG. 5 is a conceptual diagram illustrating example computing device 502 including example contextual user interface elements 528, in accordance with one or more techniques of this disclosure. Computing device 502, additional sensors 512B-512N, contextual UI controller 516, UI control configurations 526, apps 518, UI module 514, OS 530, power sources 548, processors 542, and communication units 546 of FIG. 5 may be example or alternative implementations of computing device 202, input devices 212, contextual UI controller 216, UI control configurations 226, applications 218, UI module 214, OS 230, power source 248, processor 242, and communication unit 246 of FIG. 2, respectively. Additionally or alternatively, computing device 502, gesture 552, housing 520, sensor 512A, contextual UI elements 528, contextual UI controls 554, contextual UI controller 516, apps 518, UI module 514, additional sensors 512B-512N, processors 542, and communication units 546 of FIG. 5 may be example or alternative implementations of computing device 302, gestures 352, housing 320, sensor 312A, contextual user interface element 328, contextual user interface control 354, contextual UI controller 316, applications 318, UI module 314, additional sensors 312B-312N, processor 342, and communication unit 346 of FIG. 3, respectively.

In the example of FIG. 5, computing device 502 may collect contextual signals associated with computing device 502 as application display data 524A, environmental data 524B, and phone state data 524C. Environmental data 524B may include sensor data, obtained via additional sensors 512B-512N, indicating an environmental state associated with computing device 502. Phone state data 524C may include data, obtained via power sources 548, processors 542, OS 530, and/or communication units 546, indicating a phone state associated with computing device 502. Application display data 524A may include visual and/or audio data generated by an application of apps 518 and output via a display device of computing device 502. For example, application display data 524A may include an image of a receipt, an image of a product, an image of text in a language different than a language set by an operating system of computing device 502, or a message thread.

Contextual action application programming interfaces (APIs) 566 may include one or more APIs for triggering the output of contextual user interfaces responsive to gestures (e.g., gesture 552) detected using sensor 512A. Contextual action APIs 566 may interact with apps 518 to define or modify configuration data of UI control configurations 526. For example, contextual action APIs 566 may, with explicit consent from a user operating computing device 502, communicate with a software application to store a mapping of contexts to contextual user interfaces that are assigned to a particular gesture. Contextual action APIs 566 may include one or more machine learning models trained to automatically generate contextual user interface configuration information and/or to suggest modifications to contextual user interfaces. In one instance, contextual action APIs 566 may automatically generate, according to the techniques described herein, a contextual user interface indicating options to split charges associated with items and prices identified on an image of a receipt included in application display data 524A. In another instance, contextual action APIs 566 may automatically generate, according to the techniques described herein, a contextual user interface indicating price trends associated with a product on an image included in application display data 524A. In another instance, contextual action APIs 566 may automatically generate, according to the techniques described herein, a contextual user interface indicating options to schedule an event based on a message thread included in application display data 524A.

In the example illustrated in FIG. 5, application display data 524A may include data associated with a webpage generated by a web browser application of apps 518. Contextual UI controller 516 may determine, based on application display data 524A, environmental data 524A, and phone state data 524C, that a context associated with computing device 502 is an application state associated with the webpage output using the web browser application. Contextual UI controller 516 may select, based on the context and UI control configurations 526, contextual UI element 528A configured with contextual UI control 554A and contextual UI element 528B configured with contextual UI controls 554B-554N. For example, contextual action APIs 566 may communicate with the web browser application to establish that the context associated with the web page is mapped to both contextual UI element 528A configured with contextual UI control 554A and contextual UI element 528B configured with contextual UI controls 554B-554N. Contextual UI element 528A configured with contextual UI control 554A may include a slider graphical element configured to scroll through the webpage. Contextual UI element 528B configured with contextual UI controls 554B-554N may include a split screen graphical element configured to suggest and/or perform one or more actions based on content of application display data 524A (e.g., contextual UI control 554B is a user interface control to translate recognized text data of application display data 524A, contextual UI control 554N is a user interface control to search the web for an image recognized in application display data 524A, etc.). In response to receiving an indication of gesture 552 applied to sensor 512A, contextual UI controller 516 may use UI module 514 to generate data to output contextual UI element 528A configured with contextual UI control 554A and contextual UI element 528B configured with contextual UI controls 554B-554N.

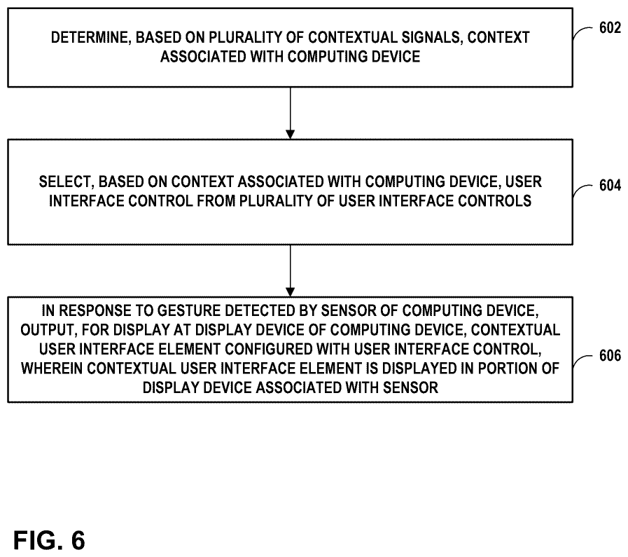

FIG. 6 is a flowchart illustrating example operations of an example computing device for outputting contextual user interface elements, in accordance with one or more techniques of the present disclosure. FIG. 6 may be discussed with respect to FIG. 1 for example purposes only.

Computing device 102 may determine, based on a plurality of contextual signals, a context associated with computing device 102 (602). Computing device 102 may select, based on the context associated with computing device 102, a user interface control from a plurality of user interface controls (604). In response to a gesture detected by a sensor of computing device 102, computing device 102 may output, for display at a display device of computing device 102, a contextual user interface element configured with the user interface control, wherein the contextual user interface element is displayed in a portion of the display device associated with the sensor (606).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperable hardware units, including one or more processors as described above, in conjunction with suitable software and/or firmware.

Various examples of the disclosure have been described. Any combination of the described systems, operations, or functions is contemplated. These and other examples are within the scope of the following claims.

Example 1: A method includes determining, by a computing device and based on a plurality of contextual signals, a context associated with the computing device; selecting, by the computing device and based on the context, a user interface control from a plurality of user interface controls; and in response to a gesture detected by a sensor of the computing device, outputting, by the computing device and for display at a display device of the computing device, a contextual user interface element configured with the user interface control, the contextual user interface element displayed in a portion of the display device associated with the sensor.

Example 2: The method of example 1, wherein the user interface control is a first user interface control, and wherein the method further comprises: ranking, based on the context, the plurality of user interface controls, wherein the first user interface control is ranked higher than a second user interface control; and wherein selecting the first user interface control comprises selecting, based on the ranking of the plurality of user interface controls, the first user interface control instead of the second user interface control.

Example 3: The method of example 2, wherein the gesture is a first gesture and wherein the method further comprises: selecting, based on the ranking of the plurality of user interface controls, a stack of user interface controls from the plurality of user interface controls, the stack of user interface controls including the second user interface control; and in response to a second gesture detected by the sensor, outputting, by the computing device and for display at the display device, the contextual user interface element configured with the second user interface control, wherein the first gesture precedes the second gesture.

Example 4: The method of any of examples 1-3, further includes in response to receiving a user input associated with the user interface control, updating the contextual user interface element based on the user input.

Example 5: The method of example 4, wherein the user input is a tactile input applied to the sensor or the display device.

Example 6: The method of example 4, wherein the contextual user interface element is a slider element, and wherein updating the contextual user interface element comprises changing a slider value of the contextual user interface element based on the user input.

Example 7: The method of example 4, wherein the user interface control includes instructions for adjusting an output setting based on the user input, wherein the output setting includes one of: a volume setting of the computing device or a display brightness setting of the computing device.

Example 8: The method of example 4, wherein the user interface control includes instructions for moving through content displayed by the display device based on the user input.

Example 9: The method of example 4, wherein the user interface control includes instructions for selecting, based on the user input, an icon from a set of icons displayed in the contextual user interface element, wherein each icon of the set of icons indicate an action contextually related to content displayed by the display device.

Example 10: The method of example 4, wherein the user interface control includes instructions for capturing, based on the user input, a portion of content displayed by the display device.

Example 11: The method of example 4, wherein the user interface control includes instructions for outputting, in the contextual user interface element, one or more images that are contextually related to content displayed by the display device.

Example 12: The method of any of examples 1-11, wherein the user interface control includes instructions for executing an action contextually related to a state indicated in the context.

Example 13: The method of any of examples 1-12, further includes obtaining, by the computing device, the plurality of contextual signals, wherein the plurality of contextual signals include content displayed by the display device, application data, sensor data, connection data, and environmental data.

Example 14: The method of any of examples 1-13, wherein the context associated with the computing device comprises one or more of a phone state, an application state, and an environmental state.

Example 15: The method of any of examples 1-14, wherein determining the context comprises: identifying a set of signals from the plurality of contextual signals obtained during a time period; generating, based on the set of signals, one or more clusters including one or more signals of the set of signals, wherein each of the one or more clusters correspond to one or more user interface controls of the plurality of user interface controls; determining a cluster of the one or more clusters, wherein the cluster indicates the context associated with the computing device.

Example 16: The method of example 15, further includes storing user interface control configuration information that at least includes the mapping of the user interface control to the cluster.

Example 17: The method of example 15, further includes updating the user interface control configuration information using a machine learning model.

Example 18: The method of example 15, wherein determining the cluster comprises determining the cluster has a greater number of signals from the set of signals than other clusters of the one or more clusters, and wherein the method further comprises ranking the cluster higher than other clusters of the one or more clusters.

Example 19: The method of any of examples 1-18, wherein the sensor includes a touch-sensitive button.

Example 20: The method of any of examples 1-19, wherein the gesture includes at least one of: one or more taps applied to the sensor, a long press applied to the sensor, or a swipe gesture applied to the sensor.

Example 21: The method of any of examples 1-20, wherein the contextual user interface element includes graphical data associated with functionality of the user interface control.

Example 22: A computing device includes at least one processor; a display device; a sensor; and a storage device that stores instructions executable by the at least one processor to: determine, based on a plurality of contextual signals, a context associated with the computing device, select, based on the context, a user interface control from a plurality of user interface controls, and in response to a gesture detected by the sensor, output, for display at the display device, a contextual user interface element configured with the user interface control, the contextual user interface element displayed in a portion of the display device associated with the sensor.

Example 23: The computing device of example 22, wherein the user interface control is a first user interface control, and wherein the storage device further stores instructions executable by the at least one processor to: rank, based on the context, the plurality of user interface controls, wherein the first user interface control is ranked higher than a second user interface control; and wherein to select the first user interface control, the storage device stores instructions executable by the at least one processor to: select, based on the ranking of the plurality of user interface controls, the first user interface control instead of the second user interface control.

Example 24: The computing device of example 23, wherein the gesture is a first gesture and wherein the storage device further stores instructions executable by the at least one processor to: select, based on the ranking of the plurality of user interface controls, a stack of user interface controls from the plurality of user interface controls, the stack of user interface controls including the second user interface control; and in response to a second gesture detected by the sensor, output, for display at the display device, the contextual user interface element configured with the second user interface control, wherein the first gesture precedes the second gesture.

Example 25: The computing device of any of examples 22-24, wherein the storage device further stores instructions executable by the at least one processor to: in response to receiving a user input associated with the user interface control, update the contextual user interface element based on the user input.

Example 26: The computing device of example 25, wherein the user input is a tactile input applied to the sensor or the display device.

Example 27: The computing device of example 25, wherein the contextual user interface element is a slider element, and wherein updating the contextual user interface element comprises changing a slider value of the contextual user interface element based on the user input.

Example 28: The computing device of example 25, wherein the user interface control includes instructions for adjusting an output setting based on the user input, wherein the output setting includes one of: a volume setting of the computing device or a display brightness setting of the computing device.

Example 29: The computing device of example 25, wherein the user interface control includes instructions for moving through content displayed by the display device based on the user input.

Example 30: The computing device of example 25, wherein the user interface control includes instructions for selecting, based on the user input, an icon from a set of icons displayed in the contextual user interface element, wherein each icon of the set of icons indicate an action contextually related to content displayed by the display device.

Example 31: The computing device of example 25, wherein the user interface control includes instructions for capturing, based on the user input, a portion of content displayed by the display device.

Example 32: The computing device of example 25, wherein the user interface control includes instructions for outputting, in the contextual user interface element, one or more images that are contextually related to content displayed by the display device.

Example 33: The computing device of any of examples 22-32, wherein the user interface control includes instructions for executing an action contextually related to a state indicated in the context.

Example 34: The computing device of any of examples 22-33, wherein the storage device further stores instructions executable by the at least one processor to: obtain the plurality of contextual signals, wherein the plurality of contextual signals include content displayed by the display device, application data, sensor data, connection data, and environmental data.

Example 35: The computing device of any of examples 22-34, wherein the context associated with the computing device comprises one or more of a phone state, an application state, and an environmental state.

Example 36: The computing device of any of examples 22-35, wherein to determine the context, the storage device stores instructions executable by the at least one processor to: identify a set of signals from the plurality of contextual signals obtained during a time period; generate, based on the set of signals, one or more clusters including one or more signals of the set of signals, wherein each of the one or more clusters correspond to one or more user interface controls of the plurality of user interface controls; determine a cluster of the one or more clusters, wherein the cluster indicates the context associated with the computing device.

Example 37: The computing device of example 36, wherein the storage device further stores instructions executable by the at least one processor to: store user interface control configuration information that at least includes the mapping of the user interface control to the cluster.

Example 38: The computing device of example 36, wherein the storage device further stores instructions executable by the at least one processor to: update the user interface control configuration information using a machine learning model.

Example 39: The computing device of example 36, wherein to determine the cluster, storage device stores instructions executable by the at least one processor to: determine the cluster has a greater number of signals from the set of signals than other clusters of the one or more clusters, and wherein the storage device further stores instructions executable by the at least one processor to: rank the cluster higher than other clusters of the one or more clusters.

Example 40: The computing device of any of examples 22-39, wherein the sensor includes a touch-sensitive button.

Example 41: The computing device of any of examples 22-40, wherein the gesture includes at least one of: one or more taps applied to the sensor, a long press applied to the sensor, or a swipe gesture applied to the sensor.

Example 42: The computing device of any of examples 22-41, wherein the contextual user interface element includes graphical data associated with functionality of the user interface control.

Example 43: Computer-readable storage media encoded with instructions that, when executed, cause at least one processor of a computing device to: determine, based on a plurality of contextual signals, a context associated with the computing device, select, based on the context, a user interface control from a plurality of user interface controls, and in response to a gesture detected by a sensor, output, for display at a display device, a contextual user interface element configured with the user interface control, the contextual user interface element displayed in a portion of the display device associated with the sensor.

Example 44: The computer-readable storage media of example 43, wherein the user interface control is a first user interface control, and wherein the instructions further cause the at least one processor of the computing device to: rank, based on the context, the plurality of user interface controls, wherein the first user interface control is ranked higher than a second user interface control; and wherein to select the first user interface control the instructions cause the at least one processor of the computing device to select, based on the ranking of the plurality of user interface controls, the first user interface control instead of the second user interface control.

Example 45: The computer-readable storage media of example 43, wherein the gesture is a first gesture and wherein the instructions further cause the at least one processor of the computing device to: select, based on the ranking of the plurality of user interface controls, a stack of user interface controls from the plurality of user interface controls, the stack of user interface controls including the second user interface control; and in response to a second gesture detected by the sensor, output, for display at the display device, the contextual user interface element configured with the second user interface control, wherein the first gesture precedes the second gesture.

Example 46: The computer-readable storage media of any of example 43-45, wherein the instructions further cause the at least one processor of the computing device to: in response to receiving a user input associated with the user interface control, update the contextual user interface element based on the user input.

Example 47: The computer-readable storage media of example 46, wherein the user input is a tactile input applied to the sensor or the display device.

Example 48: The computer-readable storage media of example 46, wherein the contextual user interface element is a slider element, and wherein to update the contextual user interface element the instructions cause the at least one processor of the computing device to change a slider value of the contextual user interface element based on the user input.

Example 49: The computer-readable storage media of example 46, wherein the user interface control includes instructions for adjusting an output setting based on the user input, wherein the output setting includes one of: a volume setting of the computing device or a display brightness setting of the computing device.

Example 50: The computer-readable storage media of example 46, wherein the user interface control includes instructions for moving through content displayed by the display device based on the user input.

Example 51: The computer-readable storage media of example 46, wherein the user interface control includes instructions for selecting, based on the user input, an icon from a set of icons displayed in the contextual user interface element, wherein each icon of the set of icons indicate an action contextually related to content displayed by the display device.

Example 52: The computer-readable storage media of example 46, wherein the user interface control includes instructions for capturing, based on the user input, a portion of content displayed by the display device.

Example 53: The computer-readable storage media of example 46, wherein the user interface control includes instructions for outputting, in the contextual user interface element, one or more images that are contextually related to content displayed by the display device.

Example 54: The computer-readable storage media of any of example 43-53, wherein the user interface control includes instructions for executing an action contextually related to a state indicated in the context.

Example 55: The computer-readable storage media of any of example 43-54, wherein the instructions further cause the at least one processor of the computing device to: obtain the plurality of contextual signals, wherein the plurality of contextual signals include content displayed by the display device, application data, sensor data, connection data, and environmental data.

Example 56: The computer-readable storage media of any of example 43-55, wherein the context associated with the computing device comprises one or more of a phone state, an application state, and an environmental state.

Example 57: The computer-readable storage media of any of example 43-56, wherein to determine the context, the instructions cause the at least one processor of the computing device to: identify a set of signals from the plurality of contextual signals obtained during a time period; generate, based on the set of signals, one or more clusters including one or more signals of the set of signals, wherein each of the one or more clusters correspond to one or more user interface controls of the plurality of user interface controls; determine a cluster of the one or more clusters, wherein the cluster indicates the context associated with the computing device.

Example 58: The computer-readable storage media of example 57, wherein the instructions further cause the at least one processor of the computing device to: store user interface control configuration information that at least includes the mapping of the user interface control to the cluster.

Example 59: The computer-readable storage media of example 57, wherein the instructions further cause the at least one processor of the computing device to: update the user interface control configuration information using a machine learning model.

Example 60: The computer-readable storage media of example 57, wherein to determine the cluster, the instructions further cause the at least one processor of the computing device to determine the cluster has a greater number of signals from the set of signals than other clusters of the one or more clusters, and wherein the instructions further cause the at least one processor of the computing device to rank the cluster higher than other clusters of the one or more clusters.

Example 61: The computer-readable storage media of any of example 43-60, wherein the sensor includes a touch-sensitive button.

Example 62: The computer-readable storage media of any of example 43-61, wherein the gesture includes at least one of: one or more taps applied to the sensor, a force press applied to the sensor, a long press applied to the sensor, or a swipe gesture applied to the sensor.

Example 63: The computer-readable storage media of any of example 43-62, wherein the contextual user interface element includes graphical data associated with functionality of the user interface control.

Example 64: A computing system comprising means for performing any of the

Example 65: Computer-readable storage media encoded with instructions that cause one or more processors of a computing system to perform any of the methods of examples 1-21.

Example 66: A computer program product comprising at least one non-transitory computer-readable media including one or more instructions that, when executed by at least one processor, cause the at least one processor to perform any of the methods of examples 1-21.

Various examples have been described. These and other examples are within the scope of the following claims.

What is claimed is:

1. A method comprising:
determining, by a computing device and based on a plurality of contextual signals, a context associated with the computing device;
selecting, by the computing device and based on the context, a user interface control from a plurality of user interface controls; and
in response to a gesture detected by a sensor of the computing device, outputting, by the computing device and for display at a display device of the computing device, a contextual user interface element configured with the user interface control, the contextual user interface element displayed in a portion of the display device associated with the sensor.

2. The method of claim 1, wherein the user interface control is a first user interface control, and wherein selecting the first user interface control comprises prioritizing, based on the context, the first user interface control over a second user interface control.

3. The method of claim 2, wherein the gesture is a first gesture and wherein the method further comprises:
selecting, based on a prioritizing of the plurality of user interface controls, a stack of user interface controls from the plurality of user interface controls, the stack of user interface controls including the second user interface control; and
in response to a second gesture detected by the sensor, outputting, by the computing device and for display at the display device, the contextual user interface element configured with the second user interface control, wherein the first gesture precedes the second gesture.

4. The method of claim 1, further comprising: in response to receiving a user input associated with the user interface control, updating the contextual user interface element based on the user input.

5. The method of claim 1, further comprising: obtaining, by the computing device, the plurality of contextual signals, wherein the plurality of contextual signals include content displayed by the display device, application data, sensor data, connection data, and environmental data.

6. The method of claim 1, wherein determining the context comprises:
identifying a set of signals from the plurality of contextual signals obtained during a time period;
generating, based on the set of signals, one or more clusters including one or more signals of the set of signals, wherein each of the one or more clusters correspond to one or more user interface controls of the plurality of user interface controls; and
determining a cluster of the one or more clusters, wherein the cluster indicates the context associated with the computing device,
wherein selecting the user interface control comprises: selecting the user interface control from the plurality of user interface controls based on a mapping of the user interface control to the cluster.

7. The method of claim 6, further comprising:
storing user interface control configuration information that at least includes the mapping of the user interface control to the cluster; and
updating the user interface control configuration information using a machine learning model.

8. The method of claim 1, wherein the sensor includes a touch-sensitive button.

9. The method of claim 1, wherein the gesture includes at least one of: one or more taps applied to the sensor, a long press applied to the sensor, or a swipe gesture applied to the sensor.

10. A computing device, comprising:
at least one processor;
a display device;
a sensor; and
a storage device that stores instructions executable by the at least one processor to:
determine, based on a plurality of contextual signals, a context associated with the computing device,
select, based on the context, a user interface control from a plurality of user interface controls, and
in response to a gesture detected by the sensor, output, for display at the display device, a contextual user interface element configured with the user interface control, the contextual user interface element displayed in a portion of the display device associated with the sensor.

11. The computing device of claim 10, wherein the user interface control is a first user interface control, and wherein to select the first user interface control the storage device stores instructions executable by the at least one processor to prioritize, based on the context, the first user interface control over a second user interface control.

12. The computing device of claim 10, wherein the storage device further stores instructions executable by the at least one processor to: in response to receiving a user input associated with the user interface control, update the contextual user interface element based on the user input.

13. The computing device claim 10, wherein the user interface control includes instructions for executing an action contextually related to a state indicated in the context.

14. The computing device of claim 10, wherein to determine the context, the storage device stores instructions executable by the at least one processor to:
identify a set of signals from the plurality of contextual signals obtained during a time period;
generate, based on the set of signals, one or more clusters including one or more signals of the set of signals, wherein each of the one or more clusters correspond to one or more user interface controls of the plurality of user interface controls; and
determine a cluster of the one or more clusters, wherein the cluster indicates the context associated with the computing device
wherein to select the user interface control, the storage device stores instructions executable by the at least one processor to: selecting the user interface control from the plurality of user interface controls based on a mapping of the user interface control to the cluster.

15. The computing device of claim 10, wherein the sensor includes a touch-sensitive button.

16. Computer-readable storage media encoded with instructions that, when executed, cause at least one processor of a computing device to:
determine, based on a plurality of contextual signals, a context associated with the computing device;
select, based on the context, a user interface control from a plurality of user interface controls; and
in response to a gesture detected by a sensor, output, for display at a display device, a contextual user interface element configured with the user interface control, the contextual user interface element displayed in a portion of the display device associated with the sensor.

17. The computer-readable storage media of claim 16, wherein the user interface control is a first user interface control, and wherein to select the first user interface the instructions cause the at least one processor of the computing device to prioritize, based on the context, the first user interface control over a second user interface control.

18. The computer-readable storage media of claim 16, wherein the instructions further cause the at least one processor of the computing device to: in response to receiving a user input associated with the user interface control, update the contextual user interface element based on the user input.

19. The computer-readable storage media of claim 16, wherein the user interface control includes instructions for executing an action contextually related to a state indicated in the context.

20. The computer-readable storage media of claim 16, wherein the instructions further cause the at least one processor of the computing device to: obtain the plurality of contextual signals, wherein the plurality of contextual signals include content displayed by the display device, application data, sensor data, connection data, and environmental data.
